(19) United States
(12) Patent Application Publication
(10) Pub. No.: US 2008/0307631 A1
(43) Pub. Date: Dec. 18, 2008

(54) METHOD FOR FORMING A PATTERN ON A GOLF CLUB HEAD

(76) Inventors: Chon-Chen Lin, Ping-Tung Hsien (TW); Shun-Fu Hu, Ping-Tung Hsien (TW); Yen-Chi Hsu, Ping-Tung Hsien (TW); Yu-Ting Kao, Ping-Tung Hsien (TW)

Correspondence Address: CHRISTIE, PARKER & HALE, LLP, PO BOX 7068, PASADENA, CA, 91109-7068, US

(21) Appl. No.: 11/764,704

(22) Filed: Jun. 18, 2007

(51) Int. Cl. B23P 17/00; B23K 26/36

(52) U.S. Cl. 29/527.4; 219/121.69

(57) ABSTRACT

A method for forming a pattern on a golf club head includes the steps of forming at least one primer layer on the golf club head, and engraving the primer layer using a laser beam to form the pattern on the primer layer. The primer layer has a dark color, and a light-transmissive protecting layer is optionally applied on the primer layer after engraving.

### BACKGROUND OF THE INVENTION

1. Field of the Invention

The invention relates to a method for forming a pattern, more particularly to a method for forming a pattern on a golf club head.

2. Description of the Related Art

Referring to FIG. 1, a conventional method for forming a pattern on a golf club head includes the steps of engraving a preliminary pattern on the golf club head using a graver, applying a protecting coating on the golf club head and treating the protecting coating such that the protecting coating merely remains on an area having the preliminary pattern, electroplating the golf club head, and removing completely the protecting coating to form the pattern on the golf club head.

Since it is required in the conventional method to engrave a preliminary pattern using a graver, the conventional method is labor-intensive, relatively difficult for forming a complicated pattern, and thus has a low productivity.

### SUMMARY OF THE INVENTION

Therefore, an object of the present invention is to provide a method for forming a pattern on a golf club head which is easy to perform so as to increase productivity and reduce production costs.

Accordingly, in a first aspect of the present invention, a method for forming a pattern on a golf club head includes the steps of:

a) forming a primer layer on the golf club head; and

b) engraving the primer layer using a laser beam to form the pattern on the primer layer.

In a second aspect of the present invention, a method for forming a pattern on a golf club head includes the steps of:

a) forming a plurality of primer layers having different colors on the golf club head; and

b) engraving the primer layers using a laser beam to form the pattern on the primer layers.

### BRIEF DESCRIPTION OF THE DRAWINGS

Other features and advantages of the present invention will become apparent in the following detailed description of the preferred embodiments with reference to the accompanying drawings, of which:

FIG. 1 is a flow diagram of a conventional method for forming a pattern on a golf club head;

FIG. 2 is a flow diagram of a first preferred embodiment of a method for forming a pattern on a golf club head according to this invention; and

FIG. 3 is a flow diagram of a second preferred embodiment of a method for forming a pattern on a golf club head according to this invention.

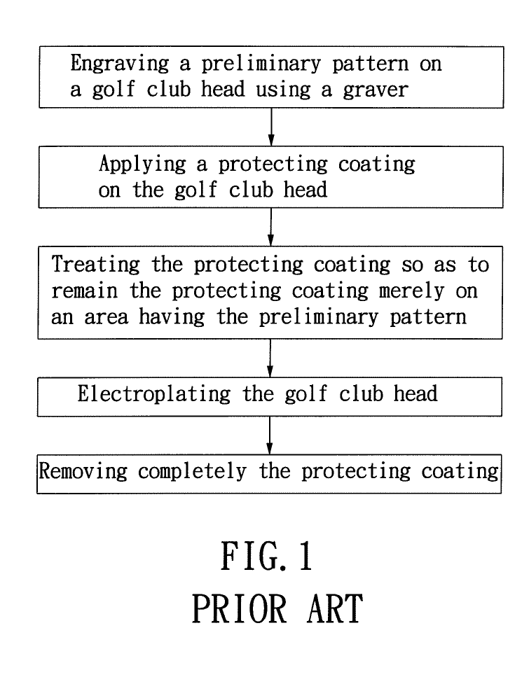

### DETAILED DESCRIPTION OF THE PREFERRED EMBODIMENTS

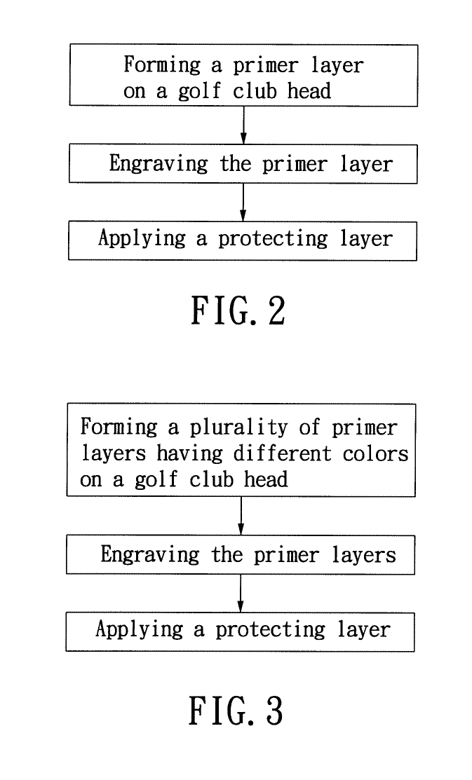

Referring to FIG. 2, the first preferred embodiment of a method for forming a pattern on a golf club head according to this invention includes the steps of:

1) forming a primer layer on the golf club head:

A primer layer is formed on the golf club head by any suitable process well known in the art, such as electrophoresis coating, electroplating, bake coating, spraying, dipping or the like. The golf club head is made of a Ni—Cr alloy. The primer layer has a dark color so as to enhance visibility of the pattern to be formed on the primer layer.

2) engraving the primer layer:

The primer layer is engraved using a laser beam to form the pattern on the primer layer. The device for emitting the laser beam is well known in the art, and thus is not described in detail herein. The variety, flexibility, and complexity of the pattern formed on the primer layer can be increased by engraving using the laser beam. Furthermore, the engraving speed of the pattern is increased using the laser beam. The pattern formed using the laser beam is recessed inward from a top surface of the primer layer and has a different color or a relatively light color, as compared to the color of the primer layer. Therefore, visibility of the pattern on the primer layer is enhanced. Additionally, since the golf club head is made of a Ni—Cr alloy, the pattern formed on the primer layer can have a light-reflective effect.

3) applying a protecting layer:

Optionally, a protecting layer is applied on the primer layer, especially when the pattern is formed on top of the golf club head, so as to protect the pattern from scratching. The process for applying the protecting layer can be conducted by any suitable manner well known in the art, and thus is not described in detail herein. The protecting layer is light-transmissive, preferably is transparent, so that the pattern is visible through the protecting layer.

Referring to FIG. 3, the second preferred embodiment of a method for forming a pattern on a golf club head according to this invention is similar to the first preferred embodiment except that a plurality of primer layers having different colors are formed on the golf club head. The differently colored primer layers can be applied on different areas of the golf club head or can be applied in a stack. Therefore, the pattern formed by the second preferred embodiment is composed of different colors. If the primer layers are applied in a stack, the pattern is formed by engraving the primer layers to different depths using the laser beam. Since the pattern is formed by engraving the primer layer(s) using the laser beam, the precision of the pattern can be increased. Furthermore, as described above, the variety, flexibility, and complexity of the pattern formed on the primer layer(s) can be increased, and the engraving speed of the pattern is increased as well.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A method for forming a pattern on a golf club head, comprising the steps of:
a) forming a primer layer on the golf club head; and
b) engraving the primer layer using a laser beam to form the pattern on the primer layer.

2. The method as claimed in claim 1, further comprising a step of applying a protecting layer on the primer layer after the step b).

3. The method as claimed in claim 1, wherein the primer layer has a dark color.

4. The method as claimed in claim 1, wherein the step a) is conducted using a process selected from the group consisting of electrophoresis coating, electroplating, bake coating, spraying, and dipping.

5. The method as claimed in claim 2, wherein the protecting layer is light-transmissive.

6. A method for forming a pattern on a golf club head, comprising the steps of:
a) forming a plurality of primer layers having different colors on the golf club head; and
b) engraving the primer layers using a laser beam to form the pattern on the primer layers.

7. The method as claimed in claim 6, further comprising a step of applying a protecting layer on the primer layers after the step b).

8. The method as claimed in claim 6, wherein the colors of the primer layers are dark.
